(19) United States
(12) Patent Application Publication
(10) Pub. No.: US 2005/0278731 A1
(43) Pub. Date: Dec. 15, 2005

(54) System and method of anonymous settop event collection and processing in a multimedia network

(75) Inventors: Kirk Cameron, Upton, MA (US); Chaitanya Kanojia, Newton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Navic Systems, Inc., Needham, MA (US)

(21) Appl. No.: 10/864,912

(22) Filed: Jun. 9, 2004

(51) Int. Cl. H04N 5/445; G06F 3/00; H04H 9/00; H04N 7/16

(52) U.S. Cl. 725/14; 725/13; 725/46

(57) ABSTRACT

A system and method is provided for event data collection and processing in a multimedia network. The server can include an event collection manager that receives messages containing event data from plural settop devices. Upon message receipt, the event collection manager accesses a database to identify a data aggregation group for the set top that sent the message and anonymously stores the event data in association with the data aggregation group. The data aggregation group can be associated with a policy that specifies anonymous storage of event data based on event type. For example, the data aggregation policy may specify storage of individual event types with personal identification information. Conversely, the aggregation policy may specify anonymous storage of individual event types anonymously excluding personal identification information. Aggregate reports can be generated from the stored event data by aggregation group.

### BACKGROUND

Multimedia content, such as television programming, is typically provided over a variety of data network infrastructure components, including so-called head end servers and household terminals referred to as set top boxes. Set top boxes handle channel access between individual household subscribers and the head end server, including channel selection and presentation of programming content through a display device, such as a television. The data network infrastructure over which the multimedia content is distributed typically includes cable, satellite, Digital Subscriber Lines (DSL) or wireless networks.

For example, in a cable network environment, content providers deliver multimedia content, such as television programs or advertisements, to a cable service provider/internet service provider (CSP/ISP) data center. The CSP/ISP data center, in turn, transmits the multimedia content to a set of head end servers distributed about a geographic region. The audio and video broadcasts are generally frequency multiplexed with data transmissions on coaxial cables extending from the head end servers to the set top boxes at individual households. In particular, each head end server distributes multimedia content over a cable network of hubs and local nodes to the set top boxes.

In order to gauge the interest of particular programming, content providers generally desire viewership data that indicates the extent to which particular programs or advertisements were watched by subscribers in particular market or demographic segments. Such information can be obtained through data collection agencies that enlist groups of individual subscribers, commonly referred to as panels, to keep track of the channels and programs that they watch. This manually tracked information is then reported back to the data collection agency for further analysis. The accuracy of such viewership data is generally limited because only a subset of all households are sampled. Moreover, such information is typically not sufficiently detailed.

### SUMMARY

In WIPO Publication No. WO 01/63448, a system and method is disclosed in which network devices, such as set top boxes, store local events in a log file and then transmit the log back to a server at a head end or data center. The server, in turn, parses the log file and updates an individual user profile to reflect changes to the demographics or channel history of that user. The updated user profiles can then be used to target specific programming and advertisements for individual households.

However, privacy is a major concern with respect to monitoring individual household viewing habits. Although there generally is a low expectation of privacy when communicating over the Internet, most people expect a higher level of privacy when watching television at home. Most find it unacceptable to have their viewing habits or other personal information tracked without their express authorization.

The present invention balances an individual's desire to maintain privacy with a content provider's need for viewership data to determine the success of particular programming or advertisements.

Embodiments of the present invention provide a system and method for event data collection and processing in a multimedia network. According to one embodiment, a server is coupled to a database that defines a plurality of data aggregation groups. Each group includes a plurality of set top devices as members that are characterized by a common set of attributes. The server includes an event collection manager that receives messages from a plurality of set top devices. Each message contains a device identifier and event data. As each message is received, the event collection manager reads the device identifier from the message and accesses a database to identify the data aggregation group or groups having the source device as a member.

The event collection manager then stores the event data anonymously in a database table or other database structure for that group, discarding or excluding any personal identification information (such as a MAC address or other device identifier or any information directly linked to the user of the source device) that is associated with the source device in order to maintain anonymity. For each data aggregation group, aggregate reports can be generated from the anonymously stored event data for distribution to content providers in order to assess the interest of particular programming without divulging the identity or characteristics of the household subscribers.

As this process is performed by the event collection manager, the personal identification information is preferably never stored in the database for any amount of time and is thus impervious to disclosure to those with access (whether authorized or not) to the database.

According to another embodiment, each data aggregation group that is defined in the database is associated with a data aggregation policy for more flexibility in aggregating event data. The data aggregation policy specifies whether event data should be stored anonymously or not based on its event type. Examples of event types include tuner events, diagnostic events, promotion events, polling events or clickstream events (e.g. navigational events). After identifying the corresponding data aggregation group, the event collection manager reads the data aggregation policy for that group and stores the event data based on its event type according to the policy. For example, tuner event data and other clickstream data may be stored anonymously, while diagnostic event data may be stored along with personal identification information, such as the device identifier.

According to another embodiment, event types which are stored anonymously by most aggregation groups may also be stored on a non-anonymous basis by settop devices that are a member of certain aggregation groups. For example, viewers who are not concerned about their privacy may opt to voluntarily join a panel which will store their tuner or other event data on an individual level with personal identification information. These settop devices would be members of an aggregation group with an aggregation policy that stores event data with personal identification information. Although the non-anonymously stored event data may be aggregated with other event data, the personal identification information linked to the event data would persist in the database allowing for further analysis of the data (e.g., tracking a settop's viewing habits over a period of time, etc.).

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram illustrating a system for collecting and processing events anonymously from set top boxes in a multimedia network according to one embodiment;

FIG. 2A is a diagram illustrating a set of collected tuner event data according to one embodiment;

FIG. 2B is a diagram illustrating an anonymous event table storing the tuner event data of FIG. 2A without any personal identification information according to one embodiment;

FIG. 3 is a diagram illustrating a database schema that facilitates policy-based storage for set top events according to one embodiment;

FIG. 4 is a flow diagram illustrating a method for collecting and processing events from set top boxes in a multimedia network according to one embodiment;

FIG. 5 is a diagram illustrating report generation involving anonymous tuner event data according to one embodiment; and

FIG. 6 illustrates a multimedia content delivery system for anonymous event collection and processing according to a particular embodiment of the present invention.

### DETAILED DESCRIPTION OF A PREFERRED EMBODIMENT

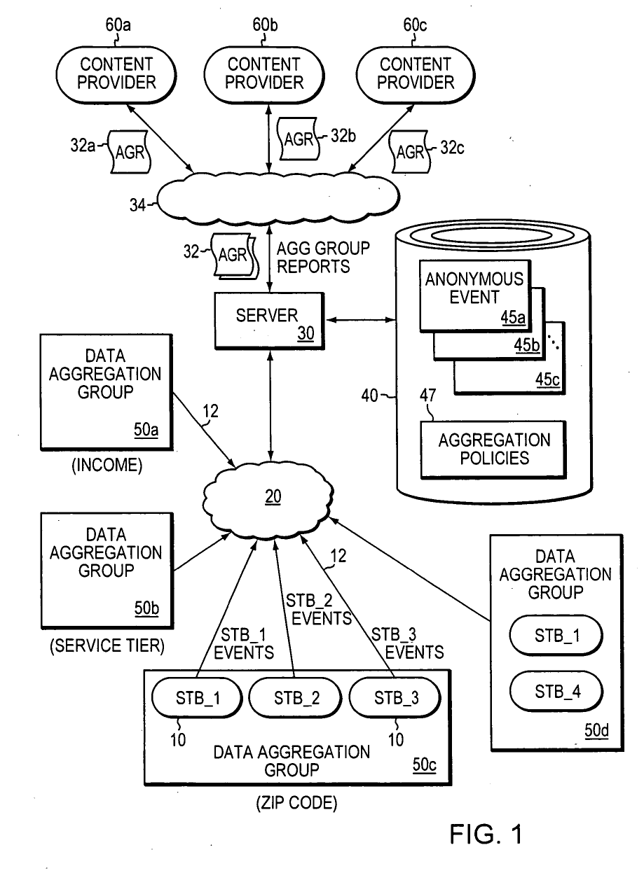

FIG. 1 is a diagram illustrating a system for collecting and processing events anonymously from set top boxes in a multimedia network according to one embodiment. In this system, each of the set top boxes 10 collects local set top events 12 and then transmits the event data over a multimedia network 20 to a central server 30 for storage in anonymous event tables or other data structures 45a, 45b, . . . 45c (collectively 45) in a database 40. Preferably, each of the anonymous event tables 45 holds event data that corresponds to a particular group of set top boxes, referred to herein as data aggregation groups 50a, 50b, 50c, 50d (collectively 50).

The database 40 defines each of the data aggregation groups 50 as including a plurality of members that have a common set of attributes, such as household income level, service tier, service area, or zip code. A set top device 10 may be a member of one or more data aggregation groups. For example, a set top device STB_1 may be a member of multiple aggregation groups 50c, 50d based on the attributes of the device.

The anonymous event tables 45 can be processed to generate aggregate group reports (AGR) 32 exclusive of any personal identification information. Content providers 60 can thus request these aggregate reports over a data network 34 (e.g., Internet) and use the reports to analyze the success or failure of particular programming or advertisement campaigns with respect to particular market segments as defined by the data aggregation groups. In this way, content providers can obtain valuable aggregated viewership information, while maintaining the privacy of individual households.

In operation, each of the set top boxes 10 collects local event data and transmits the event data 12 in one or more messages to the server 30. Each message contains a device identifier and the event data. The device identifier may be the network address of the set top box or may be some other unique identifier that is embedded in the message to identify the user or device. As the message is received by the server, the server reads the device identifier from the message and performs a lookup operation in the database 40 to identify the data aggregation group or groups 50 to which the originating set top belongs. The server 30 then stores the event data anonymously in an anonymous event table 45 for each group to which the set top belongs, discarding and/or excluding any personal identification information that might otherwise identify its source, such as a set top box address. The original message containing the event data and device identifier is discarded and its contents are preferably never stored in the database.

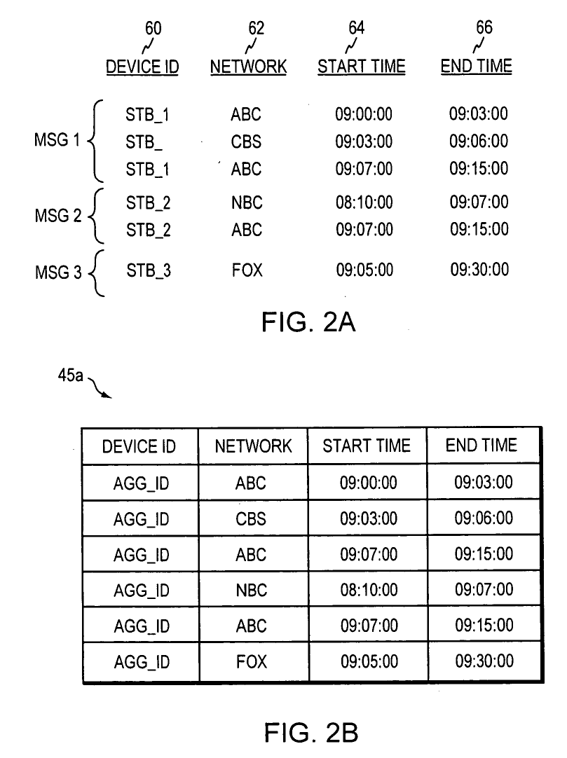

FIG. 2A is a diagram illustrating a set of collected tuner event data according to one embodiment. A tuner event is the occurrence of the set top box being tuned to a particular channel for at least a threshold time period. The tuner event data contained in an event message includes a device identifier 60, network/channel identifier 62, start time 64 and end time 66.

The device identifier 60 identifies the individual set top box from which the event was sent. In particular, the device identifier 60 can be a network address or it can be a unique identifier generated from unique parameters of a corresponding set top box that are not associated with the underlying network. The network/channel data 62 identifies the programming network and channel to which the set top box was tuned. The start time 64 is the time the set top box tuned to a particular channel, while the end time 66 is the time the set top box tuned away from that channel. Event flags (not shown) can also provide additional information collected about the event.

In this example, set top boxes having device identifiers, STB_1 and STB_2, collected and transmitted multiple tuner events to the server 30, while set top box STB_3 collected and transmitted a single tuner event. Multiple events are preferably transmitted in a single message such as MSG1.

In operation, assume that message MSG3 is received by server 30. Upon receipt of the message, the server 30 reads the device identifier STB_3 and determines that the service devices is a member of data aggregation group 50a with a corresponding anonymous event table 45a. The server then stores the event data 62, 64 and 66 anonymously as shown in FIG. 2B.

FIG. 2B is a diagram illustrating an anonymous event table storing the tuner event data of FIG. 2A without any personal identification information according to one embodiment. In particular, the server 30 stores entries containing tuner event data (e.g., network/channel identifiers, start and end times) in the anonymous event table 45a. The event data from MSG3 is shown in the bottom entry of table 45a. The device identifier and any personal identification information associated with it are excluded from entry into the anonymous event table 45a. Instead, an aggregation identifier AGG_ID is stored in place of the actual device identifier making it impossible to determine the originating set top box for each of the individual event data entries. In addition, there is preferably nothing in the database that associates a particular AGG_ID with any device identifier. In this way an individual subscriber's privacy is maintained, while the fact that an event has occurred is stored and can be used in aggregate reporting back to the content providers.

There are some cases in which it is acceptable to store event data with personal identification information. For such event types it may not be necessary to store event data anonymously, because they are less personally invasive than other event types. For example, diagnostic event data that indicate the functional state of a set top box is not related to any personal characteristics of a household viewer. In another example, some individual household subscribers may not be particularly sensitive to privacy concerns and may be willing to opt into a panel of subscribers so that their viewing habits may be monitored.

In order to accommodate these cases, each data aggregation group 50 is preferably associated with an aggregation policy 47 that enables anonymous storage of event data according to event type. Thus, an aggregation policy 47 provides more flexibility by identifying only certain event types that require anonymous storage, while allowing other event data to be individually stored in association with personal identification information. For example, an aggregation policy can be defined for a data aggregation group such that tuner events are stored anonymously, while diagnostic events are stored with personal identification information. Individual event data that is associated with personal identification information can be stored in a different set of tables, referred to herein as panel event tables (not shown). In another example, if certain subscribers have voluntarily joined a panel and have consented to having their viewing habits monitored (i.e., storing tuner data with their personal identification information), these panel members could form an aggregation group which would have an aggregation policy that stores tuner data with personal identification information in panel event tables.

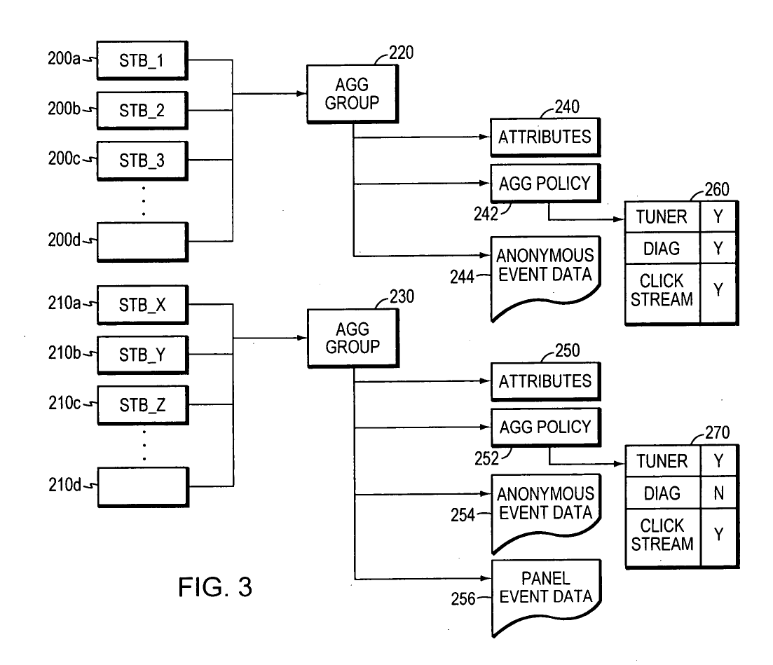

FIG. 3 is a diagram illustrating a database schema that facilitates policy-based storage for set top events according to one embodiment. In this schema, data aggregation groups 220, 230 are defined in a relational database. Each data aggregation group 220, 230 is associated with an aggregation policy 242, 252 respectively. Each aggregation policy 242, 252 includes policy data 260, 270 respectively that specifies, for each event type, whether or not anonymous storage is required. For example, the policy data 260 specifies anonymous storage of all defined event types, e.g., tuner, diagnostic, and clickstream events. Similarly, the policy data 270 specifies anonymous storage for all tuner and clickstream events, while diagnostic events can be stored in association with personal identification information. Clickstream events may correspond to viewer interactions, including interactions effected through commands issued through a remote control device (e.g., electronic guide navigation, program selection and control, etc.).

Each of the data aggregation groups 220, 230 are used to combine information sent from multiple set top boxes into a single depository, such as anonymous event tables 244, 254, making it difficult, if not impossible, to determine the originating set top boxes of the anonymous event data. In addition, configurable rules may be established to further preserve the anonymity of the collected event data. For example, a rule could state that event data will not be stored in an anonymous table for an aggregation group unless the aggregation group has at least some minimum number of settop devices as members (as may be configured by the party collecting the event data). These rules could be configured based on the attributes associated with an aggregation group (e.g., an aggregation group based on income level might have a higher minimum-member level than one based on zip code or service tier).

In addition to providing anonymity, data aggregation groups 220, 230 provide contextual information (e.g., demographic) that is used during the reporting process. Multiple data elements define the particular attributes 240, 250 of the data aggregation group 220, 230. Attributes 240, 250 contain data elements that can be used in the group definition as long as the data elements themselves do not contain any personal identification information. Examples of acceptable data elements for attributes 240, 250 include zip code, income level, service tier, and service area. Examples of non-usable data elements as group attributes include MAC address, device identifiers, account numbers, street addresses, and set top device serial numbers.

In operation, when the server 40 receives an event message from a set top box, the server preferably uses a device identifier included in the message in order to identify the data aggregation group or groups to which the set top belongs and the corresponding data aggregation policy for each aggregation group. For example, set top boxes having a device identifier 210 are members of data aggregation group 230 that applies data aggregation policy 252. Thus, whenever the server 40 receives a tuner event from a set top box 210, the tuner event data is stored anonymously in anonymous event table 254 without any personal identification information. Conversely, whenever the server 40 receives a diagnostic event from a set top box 210 the event data is stored in a panel event table 256 in association with personal identification information. The personal identification information may be a reference to a corresponding device identifier 210, such as STB_X, which can be further associated with a user profile containing, for example, demographic information (not shown). Preferably, personal identification information is not associated with any event data unless expressly authorized by a household subscriber who opts into a data aggregation group having an aggregation policy that facilitates such monitoring.

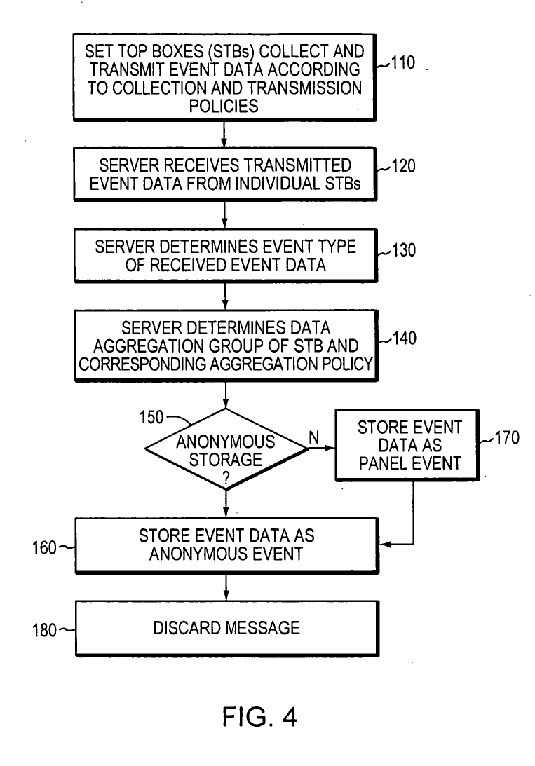

FIG. 4 is a flow diagram illustrating a method for collecting and processing events from set top boxes in a multimedia network according to one embodiment.

At 110, set top boxes 10 collect and transmit events according to collection and transmission policies. In particular embodiments, the collection and transmission policies are provided by the server 40 to each of the individual set top boxes. The collection and transmission policies govern the manner in which a set top box tracks, collects, records and ultimately transmits set top event data back to the server.

As a further privacy consideration, in one particular embodiment each settop device could have a basic collection policy associated with it that would determine whether the settop device would even collect any event data at all (whether or not the settop device was a member of an aggregation group that stored anonymously or not). Such a collection policy would enable a situation where a household subscriber could “opt out” of the collection of any event data. If a settop device had opted out, the settop device would not send any messages containing event data to the server. Similar to aggregation policies, such a collection policy might have different values for different event types (e.g., a collection policy might dictate that the settop device not send any tuner data or clickstream event data but it would collect diagnostic data).

At 120, the server 40 receives event data in a message transmitted from an originating set top box 10. The message can contain event data for multiple events.

At 130, the server 40 determines the event type of the received event data. For example, the event type may be a tuner event, a diagnostic event, a promotion event, a polling event, clickstream event (e.g. navigation event) or even a third party-defined event.

A tuner event occurs whenever the set top box is tuned to a particular channel for a predetermined dwell time. A diagnostic event corresponds to specific operating parameters of the set top box including memory utilization and power status, for example. A promotion event corresponds to a user response to the presentation of a promotion. Promotions are generally icons or graphic images with links to host web servers overlaying a video display, but also includes audio and video clips or data streams. A polling event occurs whenever the viewer has responded to an interactive poll (using the remote control or other device) and the polling event data would contain the viewer's answer to the poll. A navigation event would contain data on how a viewer interacted with an interactive application (e.g., how a viewer used an interactive program guide) based on collecting the arrows and other buttons on the remote that were pushed by the viewer and the order in which they were pushed. Such a navigation event is an example of a clickstream event which can describe, for example, any data collected with respect to buttons pushed on a remote control device (e.g., measurement of a certain feature on the remote or the use of play, pause and rewind buttons on a settop box that has a digital video recorder).

At 140, the server 40 accesses a database 40 to determine the data aggregation group or groups 45 of which the originating set top box is a member and the corresponding data aggregation policy 47 for each group.

At 150, the server 40 determines, based on the event type, whether or not to store the event data anonymously according to the data aggregation policy 47. For example, if the data aggregation policy 47 indicates anonymous storage for the event type, the event data is stored in one of the anonymous event tables 45 for that data aggregation group at 160. If not, the event data is stored in a panel event table in association with personal identification information at 170. Preferably, the panel event data is also stored in one of the anonymous event tables (as a result of the associated set top device also being a member of an aggregation group with an aggregation policy that stores event data anonymously or otherwise) for accurate aggregate data reporting at 160.

At 180, the original message containing the event data and device identifier is discarded and its identifying contents are preferably never stored in the database.

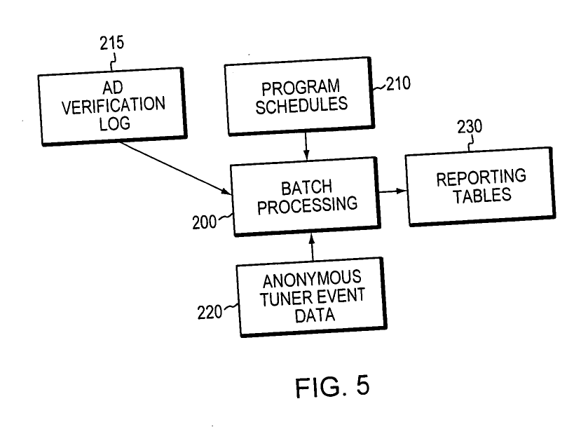

FIG. 5 is a diagram illustrating report generation involving anonymous tuner event data according to one embodiment. In this example, the server 40 performs batch processing 200 in which program schedules 210 and anonymous tuner event data 220 are combined to assign viewership to individual television programs. The anonymous tuner event data 220 may be obtained from particular anonymous event tables 47 in order to report program viewership corresponding to particular demographic or market segments. Alternatively, the anonymous tuner event data 220 can include data from all of the anonymous event tables 47 to report total program viewership regardless of market segmentation. In addition, the batch processing 200 may include matching verification logs 215 from advertisement inserters to generate reporting tables 240 that include advertisement impression counts.

Tuner events are batched processed on a periodic basis. The primary purpose of the batch process is to store the results of long running calculations for later use in report processing. Minimal processing is required to produce a report once the periodic batch process is complete. The aggregation and summarization process builds a series of reporting tables 230 each focused on a given set of reporting requirements. Such reporting tables 230 include program/half hour reporting tables, network/day part reporting tables and other common reporting tables.

The specific nature of the batch process is driven by the requirements of the underlying reports. However, certain aspects of the process are common to all reports. For instance, the batch process combines detailed anonymous tuner events with programs schedule information. Also, tuner event values for a particular aggregation group are totaled and stored for later reporting. Examples of this sort of information include active settop counts by group and by zip code.

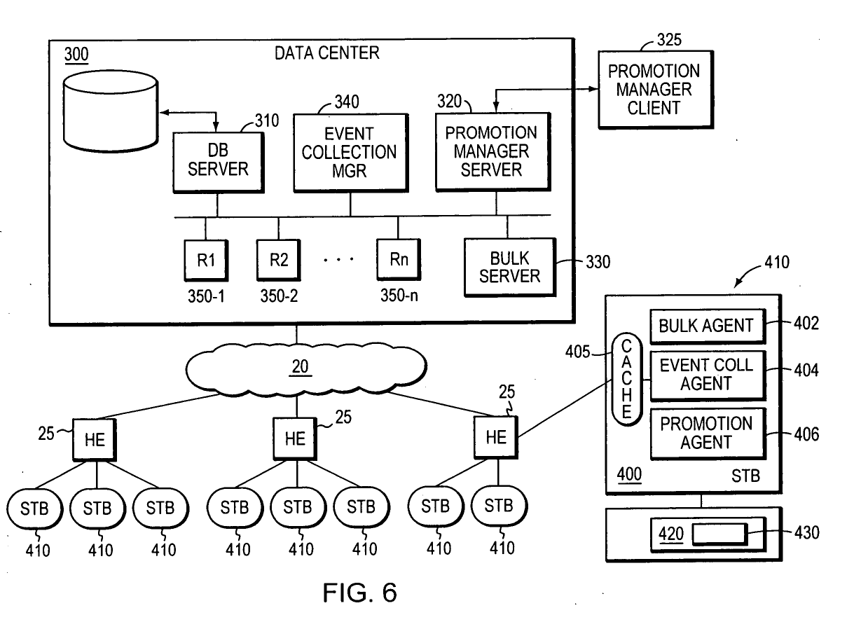

FIG. 6 illustrates a multimedia content delivery system for anonymous event collection and processing according to an alternate embodiment. Embodiments of the multimedia content delivery system allow advertisers and service providers the ability to effectively utilize a multimedia network for targeting multimedia content at consumers through a large number of set top boxes 410 connected to respective video displays 420, such as televisions.

The multimedia content delivery system implements the targeting of multimedia content, including promotions, through communication between a promotion server subsystem 300 located at a data center and a promotion agent subsystem 400 embedded within each of the set top boxes. The promotion server subsystem 300 and the promotion agent subsystems 400 communicate with each other through a combination of application-level messaging and serialized bulk data transmissions. Promotions are generally icons or graphic images with links to host web servers overlaying a video display, but also includes audio and video clips or data streams.

In particular, the promotion server subsystem 300 includes a database server 310, a promotion manager server 320, one or more bulk data servers 330, a promotion manager client 325, an event collection server 340, and a bank of routers 350-2, 350-2, . . . , 350-n. The promotion agent subsystem 400 embedded in each of the set top boxes 410 includes a promotion agent 406, an event collection agent 404 and a bulk data agent 402.

The routers 350 communicate with the set top boxes 410 through a data network 20 which may itself may include a hierarchy of routers and bulk servers (not shown in FIG. 6). Ultimately each of the set top boxes is connected to the network 20 through a head end location 25. In a typical cable television network there may be thousands of network devices connected to a particular head end, in there may be thousands of head ends 25.

In determining which content to deliver to the set top boxes, the event collection manager 340 of the promotion server subsystem 300 receives event data from the promotion agent subsystem 400 in each of the set top boxes. In television networks, the data collected by the promotion server subsystem 300 may include tuner data (i.e., a history of channels watched) in responses to past promotions. This history is kept on a relatively fine time scale, such as five seconds. In this way, it can be determined how long a particular promotion was deployed, or even which portions of a promotion or video program were viewed. The event collection manager 340 generates anonymous event tables from the event data for each of the data aggregation groups configured in the database 310. The anonymous event tables are then used to update viewership attributes of the data aggregation groups that are used for targeting promotions to member set top boxes.

To initiate event collection, the event collection manager 340 retrieves collection and transmission policies for a particular data aggregation group. A prioritization scheme can be implemented to resolve conflicts when a set top box belongs to multiple data aggregation groups with different policies. The event collection manager 340 then transmits the policies to individual set top boxes 410 of that group through message routers 350. The event collection agent 404 of a promotion agent subsystem 400 in turn initiates collection of event data according to the collection policy and temporary stores the collected data in a local event cache 405. Different collection policies can be applied to different event types. For example, event collection can be enabled or disabled for particular event types.

The transmission policy preferably defines the maximum amount of time between transmission of event messages, referred to as the maximum reporting interval. For example, the maximum reporting interval can force transmission of an event message even if the event cache 405 is partially full. Furthermore, the transmission policy can define a reporting hold-off period. A reporting hold-off period is a maximum amount of time that a set top will delay transmission of a message. Preferably, each set top box calculates a random percentage of the hold-off period before sending a message and thus reducing the occurrence of transmission spikes over the network 20. According to the transmission policy, the event collection agent 404 transmits an event message to the event collection manager 340 through the message router 350.

Upon receipt of the event message, the event collection manager 340 stores the event data as either anonymous event data or panel event data according to FIGS. 2, 3, 4A, and 4B.

While this invention has been particularly shown and described with references to preferred embodiments thereof, it will be understood by those skilled in the art that various changes in form and details may be made therein without departing from the scope of the invention encompassed by the appended claims.

1. A method of event data collection and processing in a multimedia network comprising:
receiving messages containing event data from plural set top devices;
as each of the messages is received, accessing a database to identify a data aggregation group for a corresponding one of the plural set top devices that sent the message; and
anonymously storing the event data in association with the data aggregation group.

2. The method of claim 1 further comprising:
associating the data aggregation group with a data aggregation policy that specifies anonymous storage of event data according to an event type; and
storing the event data according to the data aggregation policy.

3. The method of claim 2 wherein the event type is a tuner event, a diagnostic event, a promotion event, a polling event, or a clickstream event.

4. The method of claim 2 wherein the data aggregation policy specifies storage of individual event types with personal identification information.

5. The method of claim 2 wherein the aggregation policy specifies anonymous storage of individual event types excluding personal identification information.

6. The method of claim 1 further comprising:
generating reports from plural anonymously stored event data that are associated with the data aggregation group.

7. A system of event data collection and processing in a multimedia network comprising:
a server coupled to a database, the server including an event collection manager that receives messages containing event data from plural set top devices;
as each of the messages is received, the event collection manager accesses the database to identify a data aggregation group for a corresponding one of the plural set top devices that sent the message; and
the event collection manager anonymously stores the event data in a database in association with the data aggregation group.

8. The system of claim 7 wherein:
the data aggregation group is associated with a data aggregation policy that specifies anonymous storage of event data according to an event type; and
the event collection manager stores the event data according to the data aggregation policy.

9. The system of claim 8 wherein the event type is a tuner event, a diagnostic event, a promotion event, a polling event, or a clickstream event.

10. The system of claim 8 wherein the data aggregation policy specifies storage of individual event types with personal identification information.

11. The system of claim 8 wherein the aggregation policy specifies anonymous storage of individual event types excluding personal identification information.
